(19) United States
(12) Patent Application Publication
(10) Pub. No.: US 2020/0286105 A1
(43) Pub. Date: Sep. 10, 2020

(54) Demand Forecasting System with Improved Process for Adapting Forecasts to Varying Time Slots

(71) Applicant: Legion Technologies, Inc., Redwood City, CA (US)

(72) Inventors: Thomas Joseph, Atherton, CA (US); Yahya Sowti Khiabani, Fremont, CA (US); Sanish Mondkar, San Francisco, CA (US); Gopal Sundaram, Saratoga, CA (US)

(21) Appl. No.: 16/291,607

(22) Filed: Mar. 4, 2019

(51) Int. Cl. G06Q 30/02; G06N 20/00

(52) U.S. Cl. CPC G06Q 30/0202; G06N 20/00

(57) ABSTRACT

Disclosed is a machine learning system for adapting demand forecasts to varying time slots or intervals within a forecast day, for example when an organization's hours of operation change. The system computes a demand curve for the demand data and thereafter modifies the demand curve using curve shaping operations to adapt the demand curve to new or different time slots. Demand forecasts for the new or different time slots can thereafter be computed using values interpolated from the modified demand curve. In one embodiment, curve shaping operations are performed in a manner in which the peak values for the time slots in the demand forecast are preserved. Peak detection and segmentation operations may also be used in combination with the curve shaping to further adapt the demand forecasts.

### CROSS REFERENCE TO RELATED PATENT APPLICATIONS

This patent application is related to non-provisional U.S. patent application Ser. No. 16/210,865, entitled “Demand Forecasting Using Automatic Machine-Learning Model Selection,” filed on Dec. 5, 2018 and non-provisional U.S. patent application Ser. No. 16/238,459, entitled “Machine learning System for Demand Forecasting Using Improved Date Alignment,” filed on Jan. 2, 2019, the disclosures of which are incorporate by reference herein.

### BACKGROUND

### Technical Field

Embodiments described in this disclosure relate generally to an improved demand forecasting system based on machine learning techniques, and more particularly to a demand forecasting system for adapting forecasts using curve shaping and peak detection techniques.

### Brief Description of the Related Art

Workforce management and planning are significant drivers of profitability. In response to the rising Gig-economy and its constantly evolving labor laws, organizations are starting to invest in strategies for demand forecasting and planning ever increasing numbers. Demand forecasting systems are adapted to process historical demand data indicative of the demand for an item or service on one or more previous occasions to generate one or more demand forecasts. The demand forecasts can then be used to assist in predicting how busy an organization will be at a future point in time, which can be used for better workforce management. By forecasting labor based on historical demand data, organizations can avoid understaffing peak periods and/or overstaffing slow ones.

It is therefore becoming increasingly important for organizations to obtain accurate forecasting to anticipate staffing requirements and identify the most qualified personnel, at the right time, and the right location. But forecasting accuracy is inherently limited by the quality and/or quantity of historical demand data that is available for the analysis. If the historical demand data for a particular item or service on a previous occasion is unavailable or insufficient, then the accuracy of the forecast will degrade accordingly. For example, there may be situations in which an entity or institution may desire to change its hours of operation and desire to have meaningful information indicative of what the demand might be like for the new or different hours. As examples, an organization may decide to open earlier, open later, close earlier, close later, or open on different days of the week, or on certain holidays, special days, etc. In other cases the organization may be opening for the first time or be in their first few years of operation, in which case the historical demand data may not yet exist or may be insufficient as a basis for performing demand forecasting using conventional methods.

In such cases, the historical demand data may be limited or nonexistent, or may be different for some or all of the time slots in the day to be forecast. This can lead to difficulty in obtaining meaningful forecasts for future occasions where there may not be sufficient historical data to support the analysis.

### SUMMARY

At least certain aspects described in this disclosure are directed to systems, methods and computer readable media for implementing a machine learning system that is configured to adapt a demand forecast for a product and/or service to account for new or different time slots (periods or intervals) in the forecast day, such as in situations where an organization's hours of operation have changed. Embodiments may be realized using a machine learning system implemented in a computer hardware server comprising a processor, system memory and a network interface for communicating via one or more computer networks. The machine learning system may have access to a database system comprising one or more data storage devices adapted for collecting and storing demand data routed over the one or more computer networks from one or more data sources. The machine learning system may be configured to perform operations to adapt demand forecasts to new or different time slots.

In one aspect, the machine learning system may be configured to perform operations comprising computing an initial demand forecast including an initial set of values for an initial set of time slots in a forecast day based on processing demand data associated with the initial set of time slots, receiving an indication that the initial demand forecast is to be adapted to a second set of time slots in the forecast day, the second set of time slots including more or fewer time slots than the initial set of time slots, generating a polynomial demand curve for the initial set of time slots of the initial demand forecast, including selecting a degree of a polynomial function to fit the initial set of values for the initial set of time slots of the initial demand forecast, performing curve shaping operations to fit a scaled version of the polynomial demand curve to the second set of time slots to obtain a scaled polynomial demand curve, and computing the second demand forecast with the second set of values for the second set of time slots using values interpolated from the scaled polynomial demand curve.

The curve shaping operations may include increasing scaling of a time value of the polynomial function when the second set of time slots includes more time slots than the initial set of time slots and decreasing scaling of the time value of the polynomial function when the second set of time slots includes fewer time slots than the initial set of time slots.

In aspects, the second demand forecast is configured to adapt the initial demand forecast to the new or different time slots. The polynomial demand curve may be fit to the initial set of values for the initial set of time slots associated with the initial demand forecast and then scaled to fit the second set of time slots associated with the second demand forecast. In one embodiment, the curve shaping operations are performed on the polynomial demand curve to obtain the scaled polynomial demand curve in a manner that preserves one or more aspects of the initial demand forecast. The aspects or features of the initial demand forecast that are preserved during the curve shaping operations may include peak demand values of the initial demand forecast and/or timing information associated with the initial demand forecast.

In at least certain embodiments, peak detection may be performed to identify peaks in the initial set of values for the initial set of time slots of the initial demand forecast. In one example, the peak detection may be performed by establishing a threshold to be applied to the initial set of values for the initial set of time slots, identifying peak periods in the initial set of values, detecting a maximum value in each peak period, and identifying the detected maximum in each peak period as a peak. In one embodiment, the peak periods in the initial set of values comprise three or more consecutive time slots having a value exceeding the threshold.

In other aspects, the operations may further comprise merging outliers including identifying non-peak periods in the initial set of values that comprise two or fewer consecutive time slots having a value exceeding the threshold and merging the initial set of time slots into the nearest peak or non-peak periods in the initial demand forecast.

In yet other aspects, the operations may further comprise segmenting the initial demand forecast into one or more segments in accordance with the detected peaks, selecting each segment that includes more or fewer time slots than the corresponding initial set of time slots for the segment, generating a polynomial demand curve for each selected segment while unselected segments remain unchanged to obtain a piecewise modified polynomial demand curve, and computing the second demand forecast comprising the second set of values for the second set of time slots using values interpolated from the piecewise modified polynomial demand curve.

In one embodiment, generating a polynomial demand curve for each of the selected segments includes selecting a degree of a polynomial function to fit the initial set of values for the initial set of time slots of the initial demand forecast and fitting the polynomial function of the selected degree to the second set of time slots in the segment.

The aspects, features, and advantages of the disclosed embodiments will become apparent to those of ordinary skill in the art from the following description of specific embodiments in conjunction with the accompanying figures.

### BRIEF DESCRIPTION OF THE DRAWINGS

FIG. 1A depicts a flow chart of an example embodiment of a process for adapting demand forecasts to varying time slots in accordance with the teachings of this disclosure

FIG. 1B depicts a flow chart of an example embodiment of a process for selecting segments within a demand forecast in accordance with the teachings of this disclosure.

FIG. 2 depicts a flow chart of an example embodiment of a process for detecting peaks in a demand forecast in accordance with the teachings of this disclosure.

FIG. 3 depicts an example graph showing interpolation of polynomial functions of varying degree to fit a set of data points.

FIGS. 4A-4B depict examples of performing curve shaping operations based on time scaling in accordance with the teachings of this disclosure.

FIG. 5A depicts an example graph showing peak detection operations for a set of time slots in a forecast day in accordance with the teachings of this disclosure.

FIG. 5B depicts a graph showing an example embodiment of segmenting the demand data in accordance with the identified peaks.

FIG. 6A depicts a graph of an example embodiment of a demand curve fitted to demand data using a polynomial function in accordance with the teachings of this disclosure.

FIG. 6B depicts a graph of an example embodiment of a piecewise modified demand curve adapted to varying time slots in accordance with the teachings of this disclosure.

FIG. 7A depicts a conceptual block diagram of an example embodiment of a machine learning system for demand forecasting with an improved process for adapting demand forecasts to new or different hours of operation in accordance with the teachings of this disclosure.

FIG. 7B depicts a conceptual block diagram including further details of an example embodiment of a machine learning system for demand forecasting with an improved process for adapting demand forecasts to new or different hours of operation in accordance with the teachings of this disclosure.

FIG. 8 depicts an overview block diagram of an example data processing system upon which the embodiments described in this disclosure may be implemented.

### DETAILED DESCRIPTION

Throughout this description numerous details are set forth in order to provide a thorough understanding of the various embodiments of this disclosure, which are provided as illustrative examples so as to enable those of skill in the art to practice the embodiments. It will be apparent to those skilled in the art that the techniques described in this disclosure may be practiced without some of these specific details, or in other instances well-known structures and devices may be shown in block diagram form to avoid obscuring the principles and techniques described in this disclosure. The figures and examples provided in this disclosure are not intended to limit its scope to any single embodiment, as other embodiments are possible by way of interchange of some or all of the described or illustrated elements. Moreover, applicants do not intend for any term in the specification or claims to be ascribed an uncommon or special meaning unless such meaning is explicitly set forth herein.

Broadly speaking, when a system is forecasting demand for some item or service, it is attempting to predict the occurrence of something on a future date (referred to herein as the “forecast day” or “forecast date”) based on what the system has learned from occurrences at points in time on previous occasions. The data representing the demand for a particular item or service on one or more previous occasions is referred to in the art as historical demand data (or hereinafter “demand data”). It includes the data that provides a value, typically a number or percentage, representing what the demand for the particular item or service was on the previous occasion(s). For instance, the demand forecast may comprise the number of coffee cups sold at a particular coffee house from 9 am to 10 am on a normal weekday.

Demand forecasting systems can be improved using machine learning techniques. At a general level, machine learning involves algorithms and statistical models that computer systems can use to progressively improve performance of tasks over time without having to be programmed by a person to do so. Machine learning systems thus improve as they “learn” from collecting additional input data and evaluating corresponding output data. Machine learning models can be developed based on processing “training data” using one or more machine learning algorithms. The training data may comprise a sufficient subset of a particular dataset in order to train one or more machine learning models in the system. The “trained” machine learning model(s) can thereafter be used to make predictions or decisions about future events or data without being explicitly programmed to perform such tasks. Machine learning techniques can be utilized with demand forecasting systems to improve the analysis over time as the system obtains more demand data. Co-pending U.S. patent application Ser. Nos. 16/210,865 and 16/238,459, incorporated herein by reference above, disclose various machine learning techniques for demand forecasting operations.

### Example Processes

The following figures depict flow charts illustrating various example embodiments of processes for adapting demand forecasts to new or different hours of operation in accordance with the teachings of this disclosure. It is noted that the processes described below are exemplary in nature and are provided for illustrative purposes, and not intended to limit the scope of this disclosure to any particular example embodiment. For instance, processes in accordance with some embodiments described in this disclosure may include or omit some or all of the operations described below or may include operations in a different order than described. The particular processes described are not intended to be limited to any particular set of operations exclusive of all other potentially intermediate operations. In addition, the operations may be embodied in computer-executable code, which may cause a general-purpose or special-purpose computer processor to perform operations for providing date alignment for demand forecasts. In other instances, these operations may be performed by specific hardware components or hardwired circuitry, or by any combination of programmed computer components and custom hardware circuitry.

In certain preferred embodiments demand forecasts can be adapted to new or different time slots (for example, change in hours of operation or some other time period or time interval). The demand data (e.g., from previous days, weeks, months or years) may be unavailable or insufficient for the new or different time slots in some cases. Since the hours of operation for a particular institution or organization have changed, there may not yet be enough data generated on previous occasions to support a conventional demand forecasting analysis. In one aspect, the techniques described in this disclosure are configured to adapt demand forecasts to situations in which there may not be sufficient demand data to support demand forecasting for at least some of the time slots in the forecast day for which a demand forecast is sought.

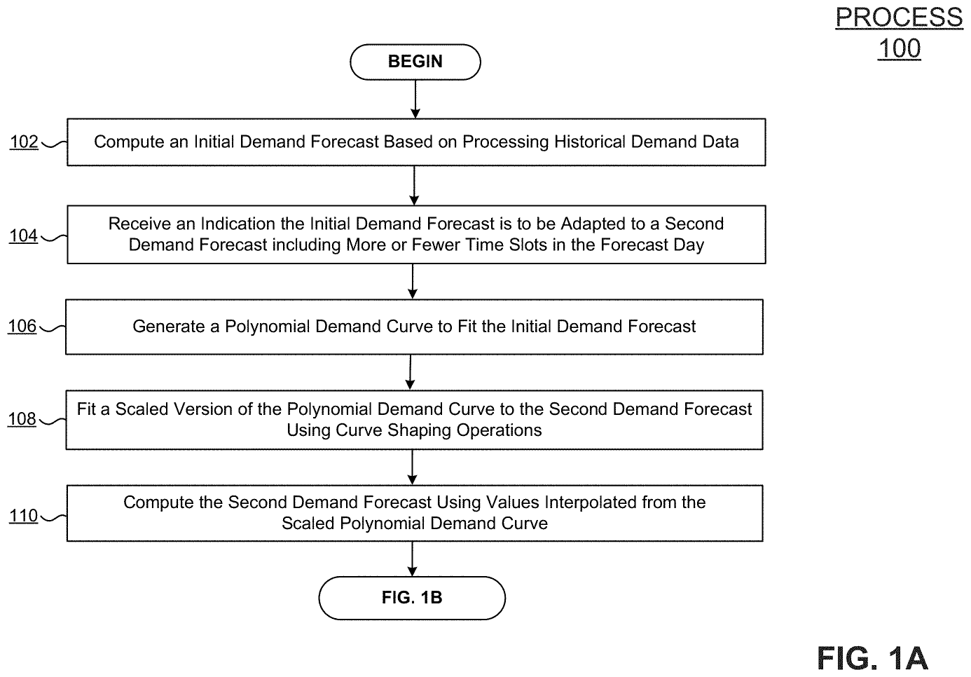

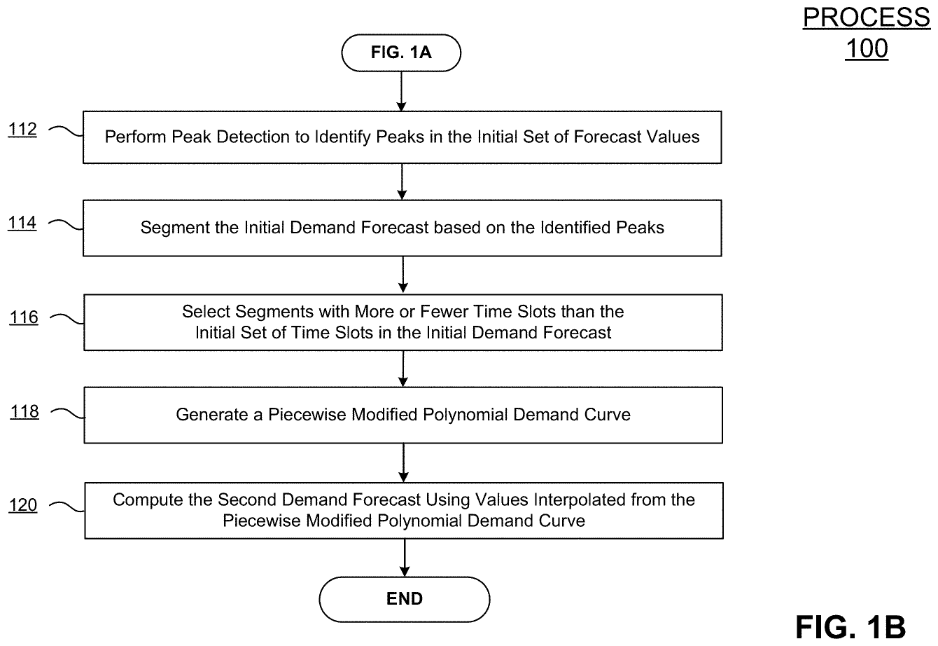

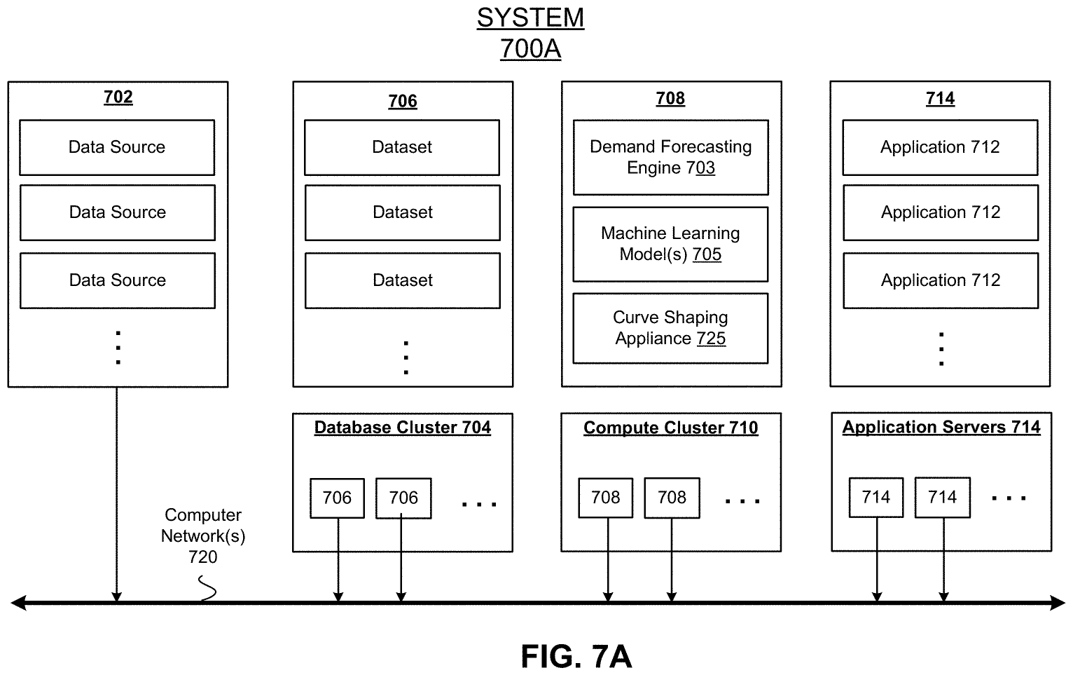

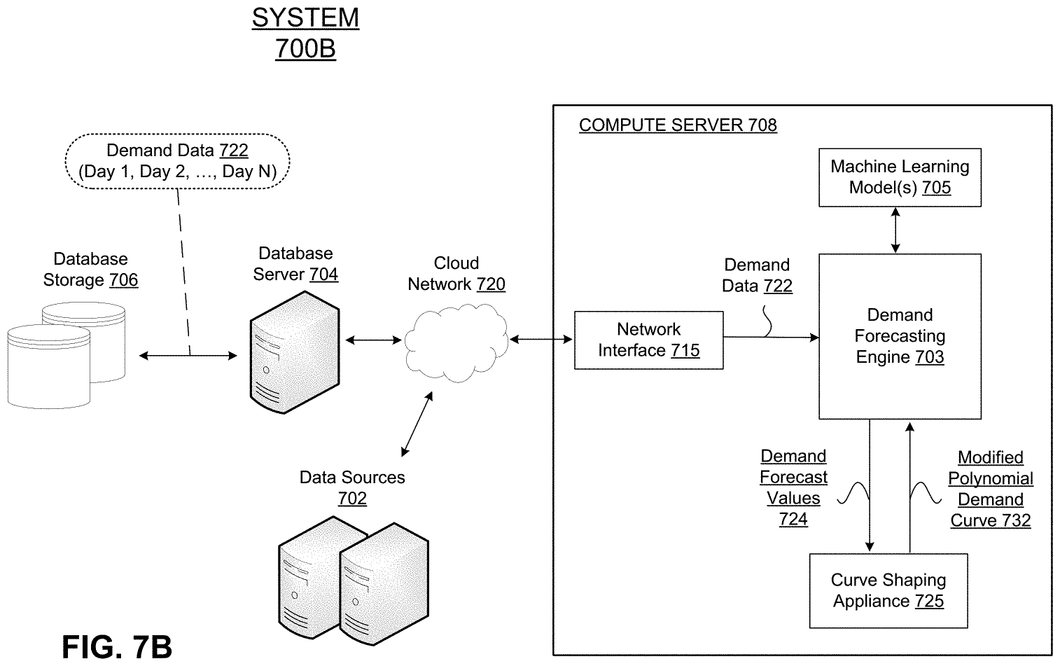

FIG. 1A depicts a flow chart of an example embodiment of a process for adapting demand forecasts to varying time slots in accordance with the teachings of this disclosure. In one embodiment, process 100 may be performed in conjunction with the curve shaping appliance 725 described below in connection with FIGS. 7A-7B. Process 100 may be implemented in a machine-learning system that includes a computer hardware server comprising at least one processor, system memory and a network interface for communicating over one or more computer networks and for accessing a database comprising one or more data storage devices. The machine learning system may be configured to receive and collect demand data corresponding to time slots in a forecast day. The demand data may have been routed over the computer network(s) from one or more sources of demand data.

The historical demand data (or simply “demand data”) supplied to the system from one or more different data sources may comprise transaction data. Recent developments in computer resources have provided organizations with the potential to collect and store vast historical databases of transaction history. Conventional applications called Enterprise Resource Planning (“ERP”) applications have been developed over the years to generate such data. Examples of such conventional ERP packages include SAP, Baan, and PeopleSoft, among many others. Volumes of historical transaction data may therefore be available to those organizations that have archived data produced by various ERP applications. Demand data may include, for example, transaction data of any data type. Transaction data that relates to purchase orders, service requests, and other activities is potentially available.

But the described aspects are not intended to be limited to any particular demand data as any number of different types of data may be used to forecast demand for the goods, products, and/or services based on any number of user-configurable factors. Depending on circumstances other data and/or data types in addition to transaction data may be relevant as input(s) to the demand forecasting system. For example, information such as store traffic and duration, etc., can be obtained from traffic counter systems, such as those provided by RetailNext®, may additionally be used as input(s) to the demand forecasting system. In at least certain aspects, the demand data may be obtained from transaction data stored in one or more databases associated with online payment processors, such as Square, Inc. and Revel Systems, Inc., which are designed to perform online payment acquiring, processing and settlement operations. Such demand data may include, for example, a description of the item or service sold, the purchase price, and the date of transaction, etc.

It should also be noted that the teachings of this disclosure are not limited to online payment processors as certain embodiments may also be used with conventional payment processing networks such as those proprietary networks of Visa and MasterCard, which are also adapted to store transaction data in one or more databases that can be accessed over one or more secure financial networks. The innovative techniques described herein are adaptable to environments in which there may be varying datasets by time, for example, by time of day or day of week, etc. The described techniques are also applicable to varying workloads within an enterprise (or other entity or organization) to be staffed with a variable number of personnel.

In the illustrated embodiment of FIG. 1A, process 100 begins at operation 102 by computing an initial demand forecast comprising an initial set of values for an initial set of time slots in a forecast day for time slots in which demand data is available. The demand data may have been previously received, collected and/or stored by the system in system memory and/or a database, system etc., and may be available for performing demand forecasting operations on the initial set of time slots.

The demand data may include demand forecast values for a particular item or service for each of the initial set of time slots. The demand data can be processed, and the resulting demand forecast values used as an indicator/predictor of the demand for a particular item, product and/or service on the forecast date. Each of the demand forecast values for time slots can be represented as discrete data points indicative of the forecast demand for a particular item or service throughout the forecast day. Taking a coffee shop for example, the input demand data may include the number and category of cups of coffee that were sold by the coffee shop on one or more previous occasions in each time increment (e.g., hour or half-hour increment) throughout the forecast day.

Process 100 continues at operation 104 wherein the system may receive receiving an indication that the initial demand forecast is to be adapted to a second set of time slots in the forecast day, the second set of time slots including more or fewer time slots than the initial set of time slots. At least some of the second set of time slots may not have sufficient demand data to support a conventional demand forecasting analysis. The indication may be internally or externally generated and may comprise an electric or control signal or group of such signals indicating to the system to begin operations in accordance with the teachings of this disclosure.

At operation 106, the system can be configured to generate a polynomial demand curve to fit the initial set of time slots of the initial demand forecast. A polynomial function may be fit to the discrete values to obtain a polynomial demand curve that graphically represents information about the demand forecast values for that particular item, product and/or service at various points in time. In one aspect, the polynomial demand curve may be fit to the initial set of values for the initial set of time slots associated with the initial demand forecast and then scaled to fit the second set of time slots associated with the second demand forecast to obtain a scaled version of the polynomial demand curve. The second set of values for the second demand forecast can then be interpolated from the scaled polynomial demand curve. In particular, the polynomial demand curve for the initial demand forecast may be generated based on (i) selecting a degree of a polynomial function to fit the initial set of values for the initial set of time slots of the initial demand forecast and (ii) fitting the polynomial function of the selected degree to the second set of time slots in the segment.

In certain preferred embodiments, the polynomial demand curve may be computed using one or more curve fitting operations. Curve fitting involves the process of constructing a curve, or mathematical function, that fits (e.g., approximates) a series of data values. In aspects, a best fit polynomial function may be computed according to conventional statistical techniques. Fitted curves provide a representation that reflects relationships among two or more variables. In certain aspects, interpolation and smoothing operations may also be performed on the data values to approximately fit the polynomial function to the data. Further, interpolation can be used to infer values of a function where no forecast data is available, or the available data is insufficient. Extrapolation techniques can also be used. Extrapolation refers to the use of a fitted curve beyond the range of observed data values and is therefore subject to a degree of uncertainty. A similar and related topic involves regression analysis techniques which also include information indicative of how much uncertainty is present in a curve that is fit to data observable with random errors.

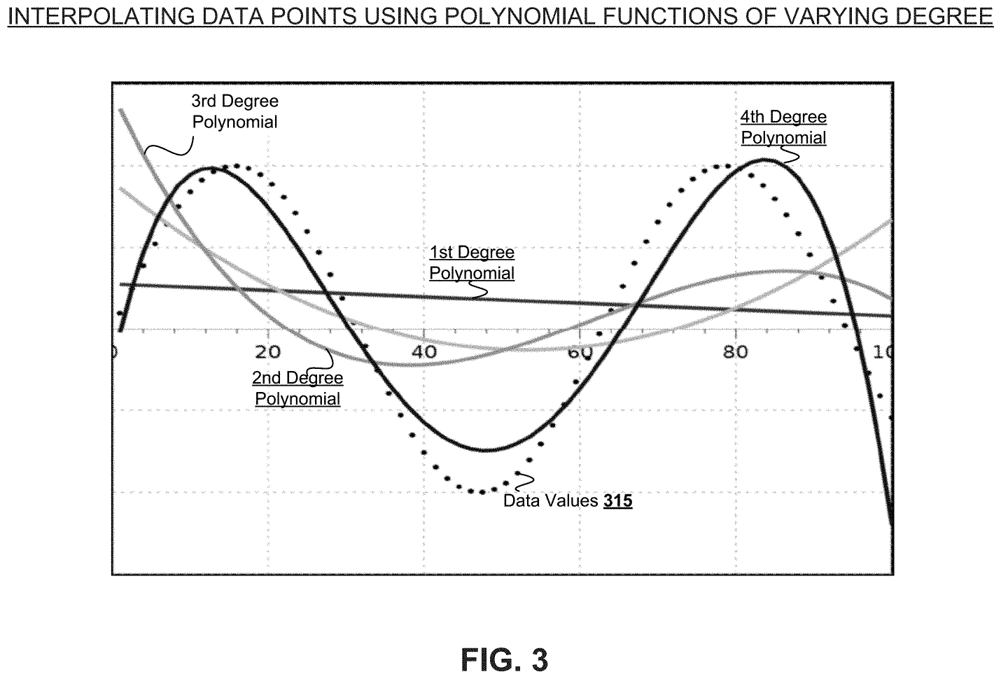

FIG. 3 depicts an example graph showing interpolation of polynomial functions of varying degree to fit a set of data values. In the simplest case, a first-degree polynomial function can be used to represent a line with a slope in an x-y coordinate system. A first-degree polynomial function takes the form of

Y=a*X+b

“Y” and “X” are the variables in the coordinate system and “a” is the slope of the line. A first-degree polynomial function can be used as an exact fit connecting any two data values having distinct coordinates in the X-Y coordinate system. As can be seen from the figure, the first-degree polynomial function comprises a line that generally follows the trend in the data values 315.

A second-degree polynomial function takes the form of:

Y=a*X²+b*X+c

A second-degree polynomial can be used to represent a parabola in an x-y coordinate system. A second-degree polynomial function can be used as an exact fit connecting any three data points. As shown in FIG. 3 the second-degree polynomial function comprises a parabola that generally fits the trend in the data values 315. In this example, the second-degree polynomial function fits the data slightly better than the first-degree polynomial, which is typically the case for complex distributions of data points—the higher the degree of the polynomial, the more accurate the interpolation to the data will generally be, but at the expense of increased complexity and processing time. Or said another way, the higher the degree of the polynomial function that is applied to fit the input demand data, the higher the accuracy the demand curve can provide in accounting for the fluctuation of demand throughout the forecast day.

A third-degree polynomial function takes the form of:

Y=a*X³+b*X²+c*X+d

A third-degree polynomial function can be used to represent cubic shapes. Cubic shapes have the following characteristics: (i) one to three roots, (ii) two or zero extrema, (iii) one inflection point, (iv) point symmetry about the inflection point, (v) range is the set of real numbers, and (vi) four data points are required to define a cubic polynomial function. A third-degree polynomial function can be used as an exact fit for four points (or constraints). Each constraint can be a data point, angle, or a curvature. As shown in FIG. 3 the second-degree polynomial function comprises a parabola that generally fits the trend in the data values 315.

Angle and curvature constraints are most often added to the ends of a curve and are referred to as end conditions. Identical end conditions are frequently used to ensure smooth transitions between polynomial curves. Higher-order constraints, such as the change in the rate of curvature, can also be added. For instance, a first-degree polynomial equation could provide an exact fit for a single point and a selected angle while a third-degree polynomial equation could provide an exact fit for two points, an angle constraint, and a curvature constraint. Many other combinations of constraints are possible for these and higher order polynomial equations.

Finally, referring to FIG. 3, a fourth-degree polynomial function is shown. A fourth-degree polynomial function takes the form of:

Y=a*X⁴+b*X³+c*X²+d*X+e

A fourth-degree polynomial function can be used to represent quartic shapes in an X-Y coordinate system, such as the one shown in the figure. A fourth-degree polynomial can be used as an exact fit for five points or constraints. As can be seen from FIG. 3, the fourth-degree polynomial function comprises a quartic shape that generally follows the trend in the data values 315. The fourth-degree polynomial provides the best fit for the data values 315. A fourth-degree polynomial should be used for accurate curve interpolation using the techniques discussed above. Higher-order polynomial functions are therefore generally preferred for interpolating demand data due to higher accuracy. In at least certain embodiments, polynomial functions of 4th, 5th or 6th may be used.

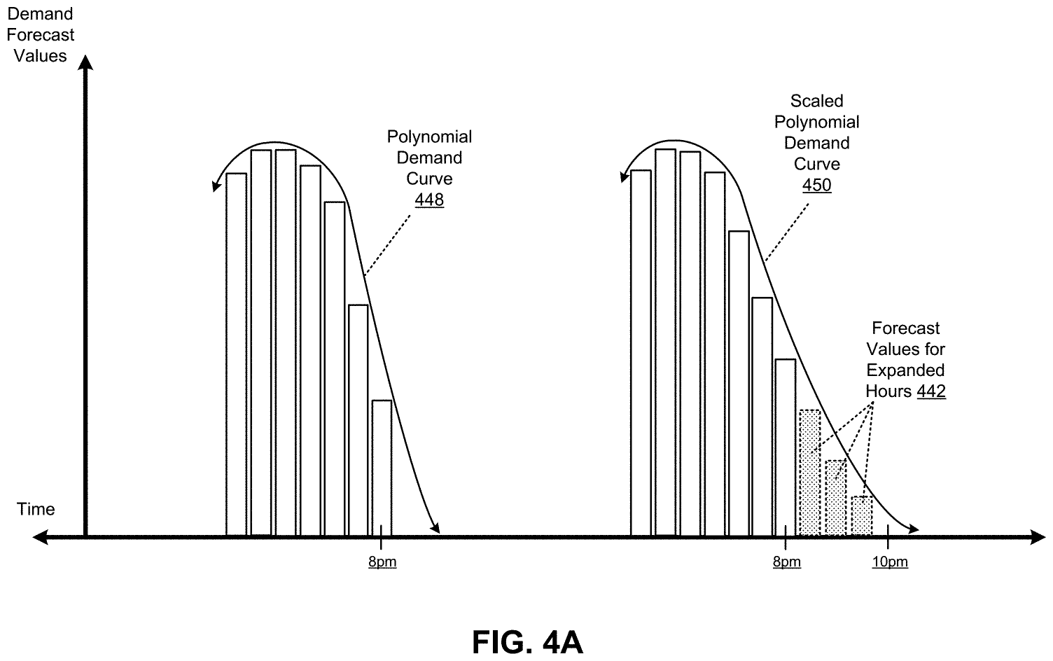

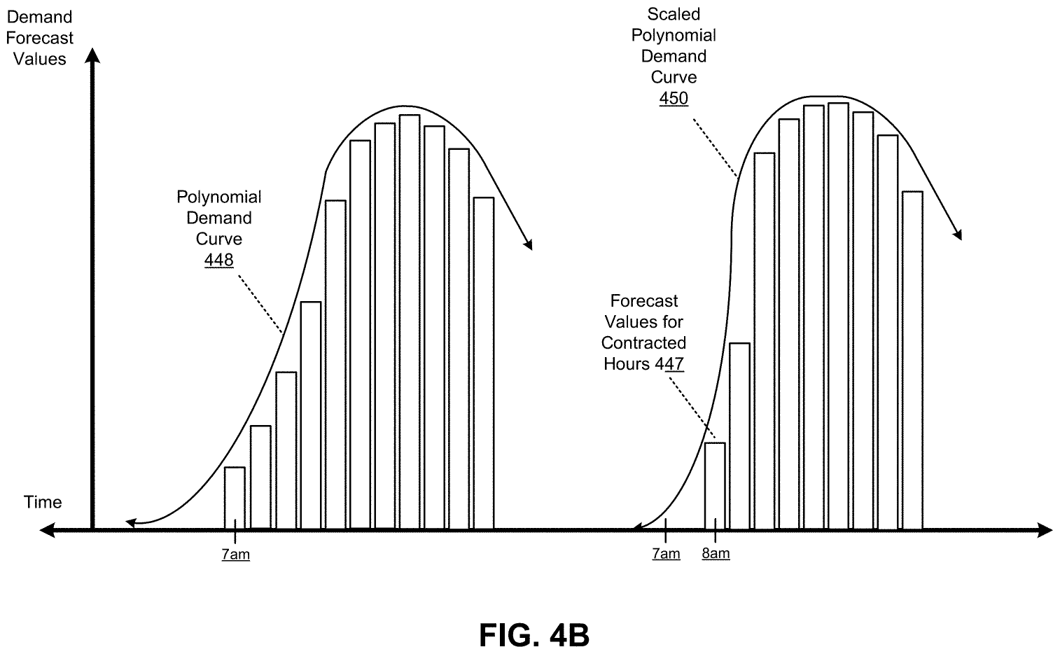

Referring back to FIG. 1A, process 100 continues at operation 108 wherein one or more curve shaping operations are performed to fit a scaled version of the polynomial demand curve to the second demand forecast to obtain a scaled polynomial demand curve. Examples of curve shaping operations based on time scaling are shown in FIGS. 4A-4B, which depict examples of performing curve shaping operations based on time scaling in accordance with the teachings of this disclosure. In one embodiment the one or more curve shaping operations are performed while preserving peaks and/or timing information in the initial demand forecast as discussed in more detail below.

The curve shaping operations may include increasing scaling of a time value of the polynomial function when the second set of time slots includes more time slots than the initial set of time slots as shown in FIG. 4A where the hours of operation (time slots) for a forecast day have increased. In this instance, the closing time has been moved out from 8 pm to 10 pm, and thus includes two additional hours. FIG. 4A shows the scaled demand curve 450, which is the time-scaled version of the polynomial demand curve 448 shown in the figure. Forecast values can be determined for the expanded hours 442 based on interpolating values from the time-scaled demand curve 450. Likewise, curve shaping operations may include decreasing scaling of the time value of the polynomial function when the second set of time slots includes fewer time slots than the initial set of time slots as shown in FIG. 4B where the hours of operation (time slots) for a forecast day have decreased. Forecast values can be determined for the contracted hours 447 based on interpolating values from the scaled polynomial demand curve 450. At operation 110 the second demand forecast comprising the second set of values for the second set of time slots can be computed, determined or estimated using values interpolated from the scaled polynomial demand curve.

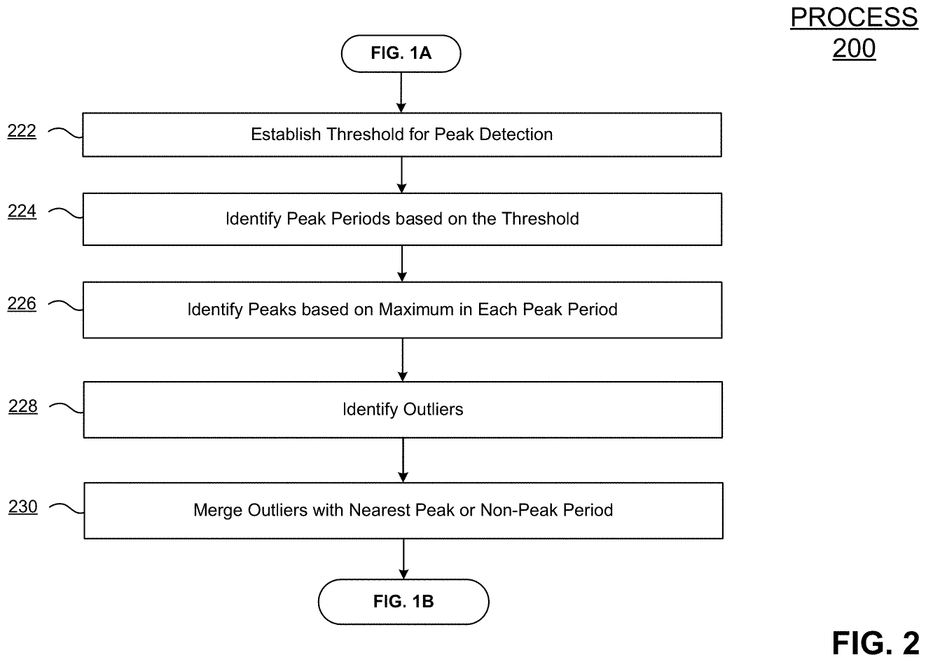

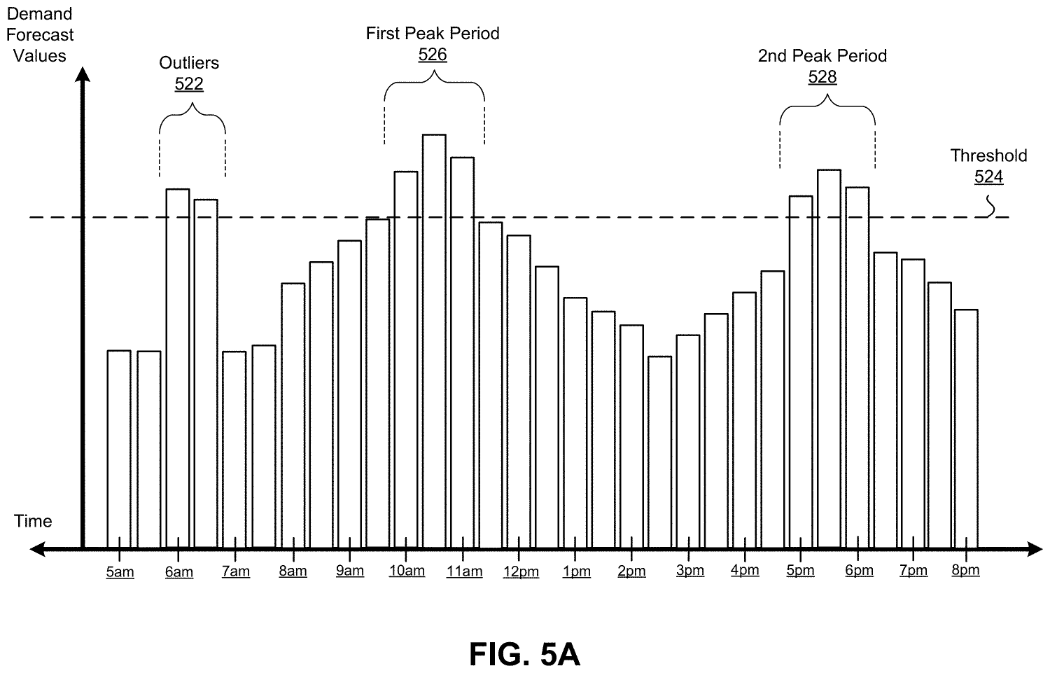

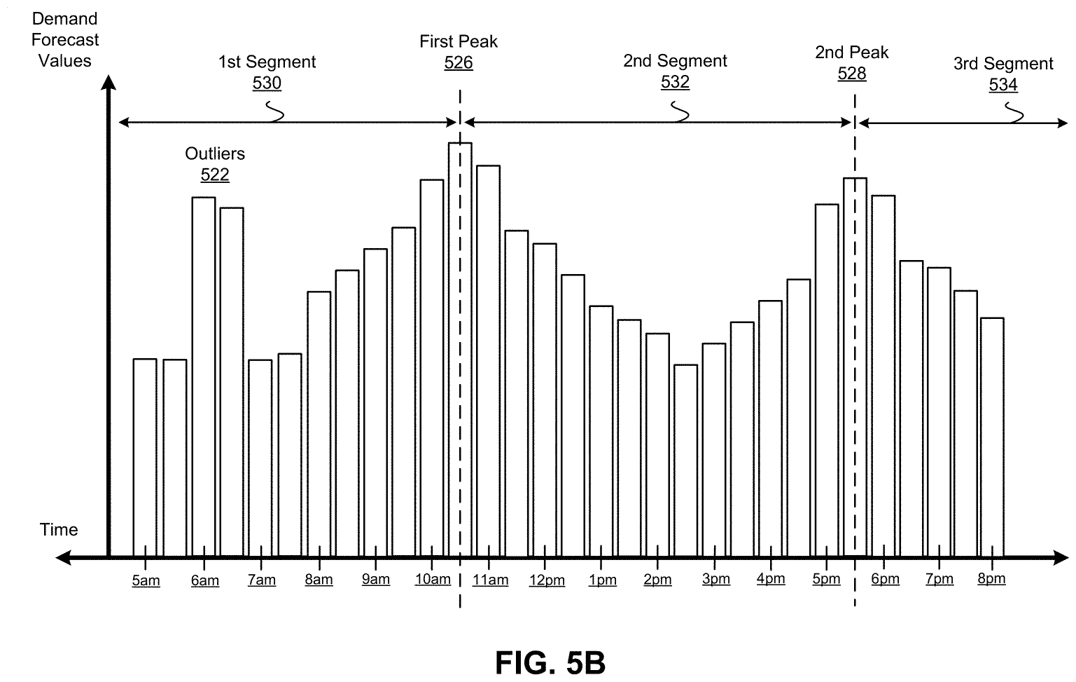

Process 100 continues to operation 112 on FIG. 1B, which depicts a flow chart of an example embodiment of a process for selecting segments within a demand forecast in accordance with the teachings of this disclosure. In the illustrated embodiment, peak detection is performed at operation 112 to identify peaks in the initial demand forecast values for the initial set of time slots. A flow chart of one example peak detection algorithm is shown and described below with respect to FIG. 2 and a graphical representation of example peak detection operations is shown and described below with respect to FIG. 5A.

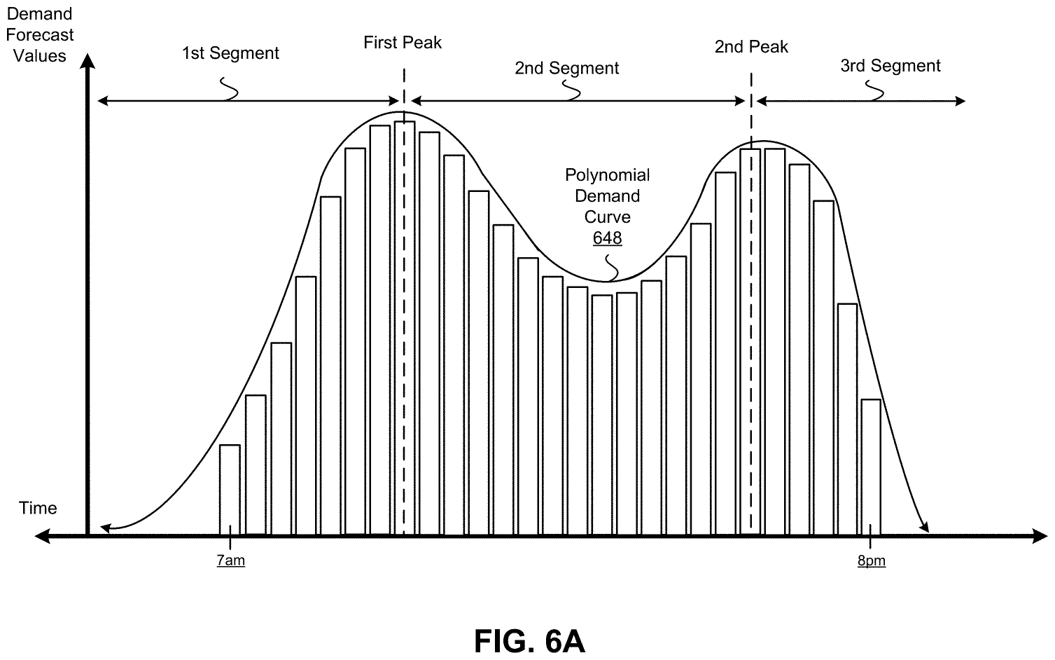

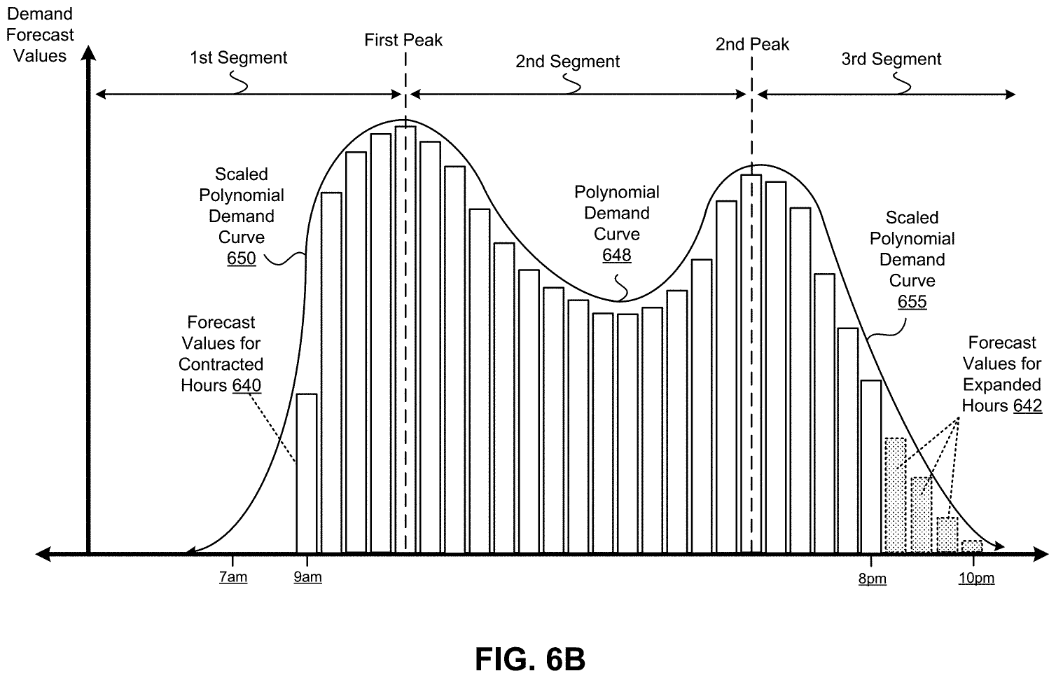

At operation 114 the polynomial demand curve for the initial demand forecast is segmented into one or more segments in accordance with the detected peaks. A graphical representation of examples of segmentation operations is shown and described below with respect to FIG. 5B. At operation 116, each segment can be selected that includes more or fewer time slots than the corresponding time slots from the initial demand forecast for that segment. For example, in cases where an organization decides to increase its hours of operation, there will be more time slots to be forecast than the corresponding time slots available from the initial demand forecast for those segments. Likewise, in cases where an organization decides to decrease its hours of operation, there will be fewer time slots to be forecast than the corresponding time slots from the initial demand forecast. FIG. 6B, discussed in detail below, depicts an example case where time slots to be forecast have been decreased at opening and increased at closing.

At operation 118 a polynomial demand curve is generated for each selected segment while unselected segments remain unchanged to obtain a piecewise modified polynomial demand curve. In one aspect this can be performed on a segment-by-segment basis until all segments of the polynomial demand curve for the initial demand forecast have been evaluated. In one aspect, computing the polynomial demand curves for each of the selected segments may include (i) selecting a degree of a polynomial function to fit the initial set of values for the initial set of time slots of the initial demand forecast and (ii) fitting the polynomial function of the selected degree to the second set of time slots in the segment. An example of a piecewise modified polynomial demand curve is depicted in FIG. 6B.

The second demand forecast comprising a second set of values for a second set of time slots can thereafter be computed using values interpolated from the piecewise modified polynomial demand curve at operation 120.

This completes process 100 according to one example embodiment.

FIG. 2 depicts a flow chart of an example embodiment of a process for detecting peaks in a demand forecast in accordance with the teachings of this disclosure. The system can be configured to identify peak periods in the forecast data. After the demand curve has been computed for the initial set of time slots (operation 104), peaks can be detected in the demand data. In the illustrated embodiment, process 200 begins at operation 222 by establishing a threshold for conducting the peak detection operations. The threshold can be a number value or a percentage that is used for peak detection. In one aspect, setting the threshold enables the system to determine which data values in the demand curve exceed the threshold. Those values can be identified as potential peak values.

Process 200 continues to operation 224 wherein peak periods in the initial set of values are identified based on the threshold. The system can be configured such that a minimum number of data values are required to exceed the threshold in order to determine a peak period. For example, peak periods may be identified as those instances where three or more consecutive time slots have a value exceeding the threshold. In other cases more or fewer time slots having consecutive values may be chosen. A maximum in each peak period can thereafter be identified as a detected peak (operation 226).

In one optional embodiment, outlier values may be merged. Process 200 optionally continues to operation 228 wherein any outliers in the demand forecast data can be identified and handled appropriately. Outlier data values may be considered false peaks in certain cases. There are also cases where the outlier values may be false valleys within peak periods. At operation 228, one or more outliers are identified in the initial set of values for the initial set of time slots. In one aspect, the outliers may be identified as those having two or fewer consecutive time slots having a value exceeding the threshold. In other cases more or fewer consecutive time slots may be chosen.

At operation 230 the forecast data corresponding to the identified outliers can then be merged. This may be accomplished by identifying peak and/or non-peak periods in the initial set of time slots for the initial demand forecast. Non-peak periods may include one or more time slots remaining after some of the time slots have been merged into peak periods.

As an illustrative example, if there was a 7:30-8:00 am time slot with a demand of 20, an 8:00-8:30 am time slot with a demand of 25, an 8:30-9:00 am time slot with a demand of 50, a 9:00-9:30 am time slot with a demand of 20, and a 9:30-10:00 am time slot with a demand of 15. In at least certain embodiments, the 8:30-9:00 am time slot may be determined to be an outlier and not considered to be a peak period. In such a case, the time slots would be merged into a non-peak period from 7:30-10:00 am. In general, the nonpeak periods may include the periods between the peak periods (after the relevant time slots have been merged into peak periods).

This completes process 200 according to one example embodiment.

FIG. 5A depicts an example graph showing peak detection operations for a set of time slots in a forecast day in accordance with the teachings of this disclosure. In the illustrated embodiment, threshold 524 has been established. The value of threshold 524 is configurable by the user and can be set for the user's particular dataset. For example, the threshold can be set to the top 20th percentile of the data. Other threshold values can of course be used depending on the particular circumstances. The system can also be configured to repetitively process the input demand data using multiple different thresholds and then compare the results for each of the threshold values until all the peaks in a given set of data have been identified.

The system can be configured such that a minimum number of data values are required to exceed the threshold in order to distinguish between a peak and non-peak period. For instance, peak periods can be identified for instances in which there are three or more consecutive data values exceeding the threshold. FIG. 5A shows three groupings of forecast values wherein the value exceeds threshold 524, including data values at 6 am, 630 am, 10 am, 1030 am, 11 am, 5 pm, 530 pm and 6 pm time slots.

Once all the groupings of data values have been identified the system can determine which of those groupings comprises peak and non-peak periods. In FIG. 5A, the groupings of forecast values are shown to include a 1st peak period 526 at times 10 am-11 am and 2nd peak period 528 at times 5 pm-6 pm. The system can identify the groupings in 526 and 528 as peak periods because they include three consecutive forecast data values exceeding threshold 524. For that same reason outlier values 522 are not considered part of a peak period because there are only two consecutive data values having a value exceeding threshold 524. Therefore outliers 522 would not be considered a peak period under the above constraints.

For any peak period, the peak can be set equal to the maximum of the values in that peak period. For instance, the forecast value at 1030 am is the maximum in the first peak period 526 and the value at 530 pm is the maximum in the second peak period 528. In one aspect, outlier values can be identified as groupings of data values having, for example, two or fewer data values exceeding the threshold 524. In a preferred embodiment, once the outlier values 522 have been identified (i.e., data values having fewer than the minimum number of values exceeding threshold 524), the initial set of time slots in the initial demand forecast may be merged into the nearest peak or non-peak periods (operation 230). In the example of FIG. 5A the outlier 522 values for 6 am and 630 am may be merged into the nearest peak or non-peak period. Once the peak and non-peak periods have been determined, they can be used in the curve shaping operations in accordance with the teachings of this disclosure.

FIG. 5B depicts a graph showing an example embodiment of segmenting the demand forecast data in accordance with the identified peaks. The forecast data has been broken down into three segments as shown, including a first segment 530 from opening at 5 am up to and including the first peak 526, a second segment 532 delineated between the first peak 526 and the second peak 528, and a third segment 534 from the second peak 528 up through closing. As discussed previously, outliers 522 are not considered a peak and are therefore not used for determining segments.

In aspects, outliers exceeding the threshold can be merged into the nearest non-peak period. There can also be outliers that are below the threshold (false valleys). These outliers may also be merged into the nearest peak periods. If a time slot has a value below the threshold but the time slots on either side of the time slot are above the threshold, this can also be considered a type of outlier. This type of outlier can therefore be merged into its corresponding peak period. Other implementations may also perform this when two or more time slots are below the threshold in cases where the surrounding time slots may be above the threshold.

FIG. 6A depicts a graph of an example embodiment of a demand curve fitted to demand data using a polynomial function in accordance with the teachings of this disclosure. In the illustrated embodiment, the demand data values are fitted using polynomial demand curve 648. In the depicted embodiment the fitted polynomial function for demand curve 648 is shown to be a high-degree polynomial. In the figure, the forecast values have been broken down into three segments among two distinct peaks. In this example, all of the time slots for which a forecast is sought have demand data available for the analysis.

FIG. 6B depicts a graph of an example embodiment of a piecewise modified demand curve adapted to varying time slots in accordance with the teachings of this disclosure. In the illustrated embodiment, the hours of operation (time slots) have been expanded and contracted with respect to the ones shown in FIG. 6A. In particular, the hours have been contracted to open at 9 am instead of 7 am and the hours have been expanded to include additional time slots at closing time from 8 pm to 10 pm. As shown, the original polynomial demand curve 648 is still utilized in connection with the second segment wherein the time slots have not changed. There were no changes to the hours of operation during this time between the first peak and the second peak. FIG. 6B shows the corresponding forecast values for contracted hours 640 and forecast values for expanded hours 642 that have been interpolated from the piecewise modified polynomial demand curve.

In aspects, the curve shaping techniques include scaling the demand curve in one or more segments to accommodate new or different business hours. As shown in FIG. 6B, a scaled demand curve 650 is utilized to provide meaningful demand forecasts for the contracted hours of operation from 5 am to 7 am and the scaled demand curve 655 is utilized to provide meaningful demand forecasts for the expanded hours of operation from 8 pm to 10 pm. In one aspect, the demand curve 648 can be adapted in the first segment and the third segment while remaining the same in the second segment. In order to accomplish this, a modified polynomial function can be fit to the demand data for the first segment and the third segment. Given the curve fitting is performed for each segment alone (on a segment-by-segment basis), a lower degree polynomial such as a second-degree polynomial function should typically be sufficient to fit the data for the segment. In the illustrated embodiment, the modified curve 650 for the first segment and the modified curve 655 for the second segment comprise second degree polynomials represented as parabolas in the graph.

Demand forecasts can be computed based on interpolating values from the modified demand curves 650 and 655 for the selected segments and from the original polynomial demand curve for the unselected segments. In one aspect, the polynomial demand curve 648 can be shaped to accommodate the new or different business hours while at the same time preserving the peaks in the demand forecast. In addition, only segments in which the business hours (or other time slots) have changed need scaling. For other segments wherein the hours of operation have not changed, there is little use for scaling the demand curve since the demand data for those time segments is available and can be used as to forecast the demand for those time slots using conventional methods.

A two-degree polynomial should fit most data between peaks. An example for the demand curve as a function of time is as follows:

Demand=5*t²+2*t+4

The variable “t” represents the time from the start of the segment. If the demand curve was fit to a segment covering the first five hours since opening, for example, and the hours of operation are decreased by one (so that the segment is now four hours long), then the above equation for the segment can be scaled as follows:

Demand=5*(t′)²+2*(t′)+4, where t′=(5/4)*t

A scaled range can be applied for each segment in the demand curve wherein new or different hours of operation are present in order to generate the modified demand curve. Similar techniques can be applied to situations involving increased hours of operation. In those instances, the time scale is scaled up accordingly. For example, in a case wherein the hours of operation in a particular segment were increased by 2 hours (making it 7 hours long), then the above equation for that segment can be scaled as follows (again, the variable “t” represents the time from the start of the segment):

Demand=5*(t′)²+2*(t′)+4, where t′=(5/7)*t

### Example Systems

Provided below is a description of an example machine learning system for demand forecasting with improved date alignment according to the techniques set forth in this disclosure. Although certain elements may be depicted as separate components, in some instances one or more of the components may be combined into a single device or system. Likewise, although certain functionality may be described as being performed by a single element or component within a system, the functionality may in some instances be performed by multiple components or elements working together in a functionally coordinated manner. In addition, hardwired circuitry may be used independently or in combination with software instructions to implement these techniques.

Further, the features and aspects described herein are not limited to any specific combination of hardware or software. For example, the described functionality may be performed by custom hardware components containing hardwired logic for performing operations, by general-purpose computer hardware containing a memory having stored thereon programmed instructions for performing operations, or by any combination of computer hardware and programmed components. The features and aspects may also be practiced in distributed computing environments, such as in a private or public cloud-based network where operations may be performed by remote processing devices or systems that are in communication via one or more wired or wireless networks.

For purposes of this disclosure, the term “appliance” refers to a combination of specially designed software application(s) and operating system to provide a particular computing resource. The hardware and software may be provided as an integrated or cloud-based solution for a particular application.

FIG. 7A depicts a conceptual block diagram of an example embodiment of a machine learning system for demand forecasting with an improved process for adapting demand forecasts to new or different hours of operation in accordance with the teachings of this disclosure. As shown in the illustrated embodiment, system 700A includes a compute cluster 710 comprising one or multiple computer hardware servers 708 in communication with one or more data sources 702 over one or more computer networks 720, a database cluster 704 having one or more datasets 706 stored on one or more data storage devices in the database cluster 704, and one or more application servers 714 for running software applications 712. Each computer hardware server 708 may include one or more processors and various levels of system and/or cache memory and a curve shaping appliance 725 for performing the peak detection and curve shaping operations described in the disclosed embodiments to obtain a modified demand curve that is scaled to adapt to varying time slots in the forecast day. The system can forecast demand for the new or different hours of operation based on a modified demand curve.

New or updated demand data can be received by the computer servers 708 from one or multiple different data sources 702 via one or more computer networks or interconnections 720. Computer network(s) 720 can be implemented in any wired or wireless network or infrastructure, including in one or more private and/or public cloud-based networks. The data sources 702 may include point of sale (“POS”) systems that provide online payment processing and transaction data. In such embodiments, system 700A can be configured to integrate with various online POS systems (e.g., mobile payment processors such as Square, Inc. or Revel Systems, Inc.) to obtain demand data therefrom for more accurate and updated demand forecasting. System 700A can be configured to receive and store the demand data from data sources 702 into one or more datasets 706 in a data cluster 704. Each dataset 706 may contain data relating to different locations and/or categories of items for which demand forecasting is sought.

Based on the datasets 706, system 700A can thereafter compute demand forecasts for one or more forecast days for different items, products or services, etc., for one or more time slots in the forecast day. Demand drivers may include past sales, store traffic, seasonality, weather, nearby events, etc. For example, a certain bicycle shop may have three locations and the system can develop a machine learning model for each different type of product and/or service available at each of the different locations. This information can be used to predict the number and qualifications of personnel needed for each task category to be accomplished at each shop location.

System 700A further includes compute cluster 710 comprising computer servers 708 connected via computer network 720. In one aspect, computer servers 708 may be configured as machine learning systems. In the illustrated embodiment, computer servers 708 comprise a demand forecasting engine 703, one or more machine learning models 705 and a curve shaping appliance 707. In certain cases each of the machine learning models 705 may correspond with a different trained configuration of one or more machine learning algorithms. One or more software modules may be configured to run on the computer servers 708 to perform operations on the datasets 706 stored on (or otherwise accessible by) the database cluster 704. In one embodiment, the demand forecasts can be generated in 30-minute time increments for each item, product or service, or other such user-configurable level of granularity.

The machine learning model(s) 705 can be continually refined and/or retrained over time to improve the predictions and/or decisions as new data and/or data types is added to the system. The trained machine learning model(s) 705 may also be reevaluated from time to time to determine whether to retrain the model(s) based on changed conditions such as receiving new or different data or data types. Machine learning models may also be retrained when the accuracy of the model is determined to have degraded below a predetermined threshold value or as new data or data sources 702 come online. In addition, in certain cases the input data may only be partially available or incomplete, and the machine learning techniques described in this disclosure can adapt to such situations.

System 700A may be scalable to concurrently perform demand forecast modeling and analysis operations for thousands of datasets in a time frame suitable for applications 712. In one aspect, computer servers 708, database cluster 704 and datasets 706 can be hosted in an environment allowing for computer servers 708 to be added and/or removed from the compute cluster 710 based on demand—such as in a commercial cloud-based network environment-allowing the system to scale in accordance with the size of the dataset(s) 706 or other factors monitored by the system 700A.

System 700A further includes application servers 714 comprising one or more applications 712 connected via computer network 720. The one or more applications 712 running on application servers 714 can be configured to administer the selected machine learning models 705 via computer network(s) 720. Employees and employers (e.g., administrators) may access applications 712 on the system using, for example mobile devices via network 720. Desktop or mainframe computers having hardwired connections can also be used. Account information, such as login credentials, can be provided to set up accounts for users to access and configure the system. Employers can login and receive demand forecasts and can use that information to generate employee work schedules commensurate with the forecasted demand for the scheduled period.

As discussed, the system for demand forecasting according to the teachings of this disclosure may be implemented as a machine learning system. FIG. 7B depicts a conceptual block diagram including further details of an example embodiment of a machine learning system for demand forecasting with an improved process for adapting demand forecasts to new or different hours of operation in accordance with the teachings of this disclosure. In the illustrated embodiment, system 700B includes a computer server 708 in communication with one or more database servers 704 over a cloud-based network 720. Network 720 can be any wired or wireless network connection or combination thereof. The computer server 708 can be configured to access data comprising datasets in the database storage 706 via database server 704 for storage and retrieval of historical demand data 722. In one embodiment, demand data 722 may be arranged in the datasets 706 according to days, e.g., Day 1, Day 2 up to Day N.

The demand data 722 can be communicated from one or more data sources 702 and stored in a database comprising one or more data storage devices 706. Computer server 708 can retrieve the demand data 722 over cloud network(s) 720 via database server 704 and network interface 715 and can provide this information to the demand forecasting engine 703 for computing demand forecasts for one or more time slots in the forecast day. The demand data 722 can be provided to the demand forecasting engine 703 for computing the demand forecasts. To train the machine learning model(s) 705 configured on the system, the demand forecasting engine 703 can utilize a dataset of demand data 722 or a subset of that dataset. The trained machine learning model(s) 705 can thereafter be used by the forecasting engine 703 along with the demand data 722 to forecast demand for products, items and/or services for one or more time slots in the forecast day.

As shown in the illustrated embodiment of FIG. 7B, the input to the demand forecasting engine 703 includes the actual demand data 722 from one or more previous occasions. As shown, the demand forecasting engine 703 provides the computed demand forecast values to the curve shaping appliance 725, and in response thereto, receives from the curve shaping appliance 725 a modified polynomial demand curve 732 for use in the demand forecasting analysis for the time slots of the forecast day.

The curve shaping appliance 725 can be configured to perform the processing and operations for adapting forecasts to new or different hours of operation in accordance with the techniques in this disclosure. The curve shaping appliance 725 can thereafter provide to the demand forecasting engine 703 the modified demand curve 732 for use in interpolating the demand forecast to account for new or different hours of operation. This process can be repeated for each time slot to be forecasted in the forecast day and for each time new or updated demand data 722 that is routed over the computer network(s) 720 from one or more data sources 702.

The curve shaping appliance 725 communicates the modified demand curve 732 to the demand forecasting engine 703. The demand forecasting engine 703 can thereafter access historical demand data 722 and the modified polynomial demand curve 732. Specifically, the demand forecasting engine 703 can take as input for its demand forecasting modeling and analysis the date, time slot, and a number value representing the demand forecast for that time slot on one or more previous occasions and can output a number value representing the estimated demand for the time slot for that day, which in one embodiment can be determined in 30-minute timeslots.

It should also be noted that the historical data 722 can go back one or more years depending on how much demand data exists or is otherwise accessible by the system 700B. In general, the historical data 722 should not go back too far in time depending on how much circumstances have changed over time. Typically, useful historical data 722 may go back two to three years.

### Example Hardware Implementation

Embodiments of the present disclosure may be practiced using various computer systems including hand-held devices, microprocessor systems, programmable electronics, laptops, tablets and the like. The embodiments can also be practiced in distributed computing environments where tasks are performed by remote processing devices that are linked through one or more wire-based or wireless networks. A hardware module may be implemented mechanically, electronically, or any suitable combination thereof. A hardware module may include dedicated circuitry or logic that is permanently configured to perform certain operations. For example, a hardware module may be a special-purpose processor, such as a Field Programmable Gate Array (“FPGA”) or an Application Specific Integrated Circuit (“ASIC”), Programmable Logic Device (“PLD”), etc.

A hardware module may also include programmable logic or circuitry that is temporarily configured by software to perform operations. For example, a hardware module may include software executed by a general-purpose processor or other programmable processor. Once configured by such software, hardware modules may become specific machines (or specific components of a machine) tailored to perform one or more configured functions. It will be appreciated that the decision to implement a hardware module mechanically in dedicated and permanently configured circuitry, or in temporarily configured circuitry (e.g., configured by software) may be driven by cost and time considerations. Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain of the operations described in this disclosure.

Similarly, the functions described in this disclosure may be at least partially processor-implemented, with a particular processor or processors being an example of hardware. For example, at least some of the operations of a function may be performed by one or more processors or processor-implemented modules. Moreover, the one or more processors may also operate to support performance of the relevant operations in a cloud computing environment or as software as a service (“SaaS”). In addition, at least some of the operations may be performed by a group of computers (as examples of machines including processors), with these operations being accessible via a network (e.g., the Internet) and via one or more appropriate interfaces (e.g., an API).

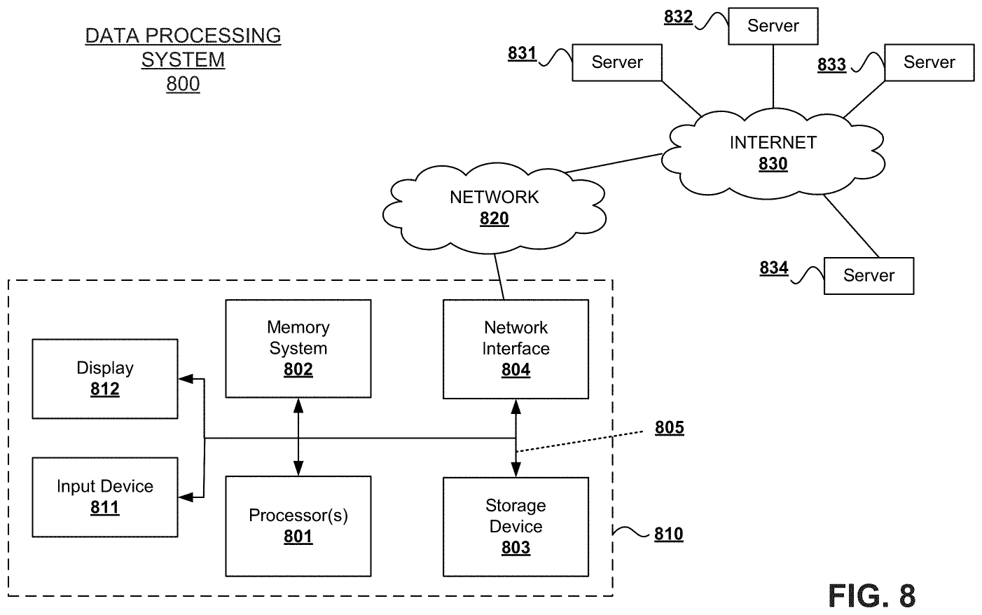

FIG. 8 depicts an overview block diagram of an example data processing system upon which the embodiments described in this disclosure may be implemented. It is to be understood that a variety of computers configurations may be used to implement the described techniques. While FIG. 8 illustrates various components of a data processing system 800, it is not intended to represent any particular architecture or manner of interconnecting components. It will also be appreciated that network computers and other data processing systems, which have fewer components or additional components, may be used. The data processing system 800 may, for example, comprise a personal computer (PC), workstation, laptop computer, tablet, smartphone or other hand-held wireless device, or any device having similar functionality.

In the illustrated embodiment, data processing system 800 includes a computer system 810. Computer system 810 includes an interconnect bus 805 (or other communication mechanism for communicating information) and one or more processor(s) 801 coupled with the interconnect bus 805 for processing information. Computer system 810 also includes a memory system 802 coupled with the one or more processors 801 via the interconnect bus 805. Memory system 802 is configured to store information and instructions to be executed by processor 801, including information and instructions for performing the techniques described above. This memory system may also be used for storing programs executed by processor(s) 801. Possible implementations of this memory system may be, but are not limited to, random access memory (RAM), read only memory (ROM), or combination thereof.

In the illustrated embodiment, a storage device 803 is also provided for storing information and instructions. Typically storage device 803 comprises nonvolatile memory. Common forms of storage devices include, for example, a hard drive, a magnetic disk, an optical disk, a CD-ROM, a DVD, a flash or other non-volatile memory, a USB memory card, or any other computer-readable medium from which a computer can read data and instructions. Storage device 803 may store source code, binary code, or software files for performing the techniques above. In addition, while FIG. 8 shows that storage device 803 as a local device connected with the components of the data processing system, it will be appreciated by skilled artisans that the described techniques may use a storage device remote from the system, such as a database or other network storage device coupled with the computer system 810 through a network interface such as network interface 804.

Network interface 804 may provide communications between computer system 810 and a network 820. The network interface 804 may be a wireless or wired connection, or any combination thereof. Computer system 810 is configured to send and receive information through the network interface 804 across one or more networks 820 such as a local area network (LAN), wide-area network (WAN), wireless or Bluetooth network, or the Internet 830, etc. Computer system 810 may access data and features on systems residing on one or multiple different hardware servers 831-834 across the network 820. Hardware servers 831-834 and associated server software may also reside in a cloud-computing environment.

Storage device and memory system are both examples of non-transitory computer readable storage media. Embodiments in this disclosure can be embodied in computer-readable code stored on any computer-readable medium, which when executed by a computer or other data processing system, can be adapted to cause the system to perform operations according to the techniques described in this disclosure. Computer-readable media may include any mechanism that stores information in a form accessible by a data processing system such as a computer, network device, tablet, smartphone, or any device having similar functionality. Examples of computer-readable media include any type of non-transitory, tangible media capable of storing information thereon, including floppy disks, hard drive disks (“HDDs”), solid-state devices (“SSDs”) or other flash memory, optical disks, digital video disks (“DVDs”), CD-ROMs, magnetic-optical disks, ROMs, RAMs, erasable programmable read only memory (“EPROMs”), electrically erasable programmable read only memory (“EEPROMs”), magnetic or optical cards, or any other type of media suitable for storing data and instructions in an electronic format. Computer-readable media can also be distributed over a network-coupled computer system stored and executed in a distributed fashion. Storage device 803 and memory system 802 are both examples of non-transitory computer readable storage media.

Further, computer system 810 may be coupled via interconnect bus 805 to a display 812 for displaying information to a computer user. An input device 811 such as a keyboard, touchscreen, and/or mouse is coupled to bus 805 for communicating information and command selections from the user to processor 801. The combination of these components allows the user to communicate with the system. In some systems, bus 805 represents multiple specialized interconnect buses.

With these embodiments in mind, it will be apparent from this description that aspects of the described techniques may be embodied, at least in part, in software, hardware, firmware, or any combination thereof. The techniques may be carried out in a computer system or other data processing system in response executing sequences of instructions stored in memory.

This disclosure has been described in terms of the representative embodiments disclosed herein. The above example embodiments should not be deemed to be the only embodiments and are presented to illustrate the flexibility and advantages of the described techniques. Other embodiments, implementations, and/or equivalents will be evident to those skilled in the art and may be employed without departing from the spirit and scope of this disclosure as defined by the following claims.

What is claimed is:

1. A method comprising:
at a machine learning system implemented in a computer hardware server comprising a processor, system memory and a network interface for communicating via one or more computer networks, the machine learning system having access to a database system comprising one or more data storage devices adapted for collecting and storing demand data routed over the one or more computer networks from one or more data sources, the machine learning system configured to perform operations to adapt demand forecasts to new or different time slots, the operations comprising:
computing an initial demand forecast comprising an initial set of values for an initial set of time slots in a forecast day based on processing demand data associated with the initial set of time slots;
receiving an indication that the initial demand forecast is to be adapted to a second set of time slots in the forecast day, the second set of time slots including more or fewer time slots than the initial set of time slots;
generating a polynomial demand curve for the initial set of time slots of the initial demand forecast, including selecting a degree of a polynomial function to fit the initial set of values for the initial set of time slots of the initial demand forecast;
performing one or more curve shaping operations on the polynomial demand curve to fit a scaled version of the polynomial demand curve to the second set of time slots to obtain a scaled polynomial demand curve, the curve shaping operations including increasing scaling of a time value of the polynomial function when the second set of time slots includes more time slots than the initial set of time slots and decreasing scaling of the time value of the polynomial function when the second set of time slots includes fewer time slots than the initial set of time slots; and
computing the second demand forecast comprising the second set of values for the second set of time slots using values interpolated from the scaled polynomial demand curve,
wherein the second demand forecast adapts the initial demand forecast to the new or different time slots.

2. The method of claim 1 wherein the polynomial demand curve is fit to the initial set of values for the initial set of time slots associated with the initial demand forecast and then scaled to fit the second set of time slots associated with the second demand forecast.

3. The method of claim 1 wherein the one or more curve shaping operations are performed on the polynomial demand curve to obtain the scaled polynomial demand curve in a manner that preserves one or more aspects of the initial demand forecast.

4. The method of claim 3 wherein aspects of the initial demand forecast that are preserved during the curve shaping operations include one or more of (i) peak demand values of the initial demand forecast and (ii) timing information associated with the initial demand forecast.

5. The method of claim 1 further comprising performing peak detection to identify peaks in the initial set of values for the initial set of time slots of the initial demand forecast.

6. The method of claim 5 wherein performing peak detection comprises:
establishing a threshold to be applied to the initial set of values for the initial set of time slots;
identifying peak periods in the initial set of values that comprise three or more consecutive time slots having a value exceeding the threshold;
detecting a maximum value in each peak period; and
identifying the detected maximum in each peak period as a peak.

7. The method of claim 6 further comprising merging outliers including:
identifying non-peak periods in the initial set of values that comprise two or fewer consecutive time slots having a value exceeding the threshold; and
merging the initial set of time slots into the nearest peak or non-peak periods in the initial demand forecast.

8. The method of claim 5 further comprising:
segmenting the initial demand forecast into one or more segments in accordance with the detected peaks;
selecting each segment that includes more or fewer time slots than the corresponding initial set of time slots for the segment;
generating a polynomial demand curve for each selected segment while unselected segments remain unchanged to obtain a piecewise modified polynomial demand curve; and
computing the second demand forecast comprising the second set of values for the second set of time slots using values interpolated from the piecewise modified polynomial demand curve.

9. The method of claim 8 wherein generating a polynomial demand curve for each of the selected segments includes (i) selecting a degree of a polynomial function to fit the initial set of values for the initial set of time slots of the initial demand forecast and (ii) fitting the polynomial function of the selected degree to the second set of time slots in the segment.

10. A system comprising:
a computer hardware server comprising a processor, system memory and a network interface for communicating via one or more computer networks, the computer hardware server implementing a machine learning system having access to a database system comprising one or more data storage devices adapted for collecting and storing demand data routed over the one or more computer networks from one or more data sources, the machine learning system configured to perform operations to adapt demand forecasts to new or different time slots, the operations comprising:
computing an initial demand forecast comprising an initial set of values for an initial set of time slots in a forecast day based on processing demand data associated with the initial set of time slots;
receiving an indication that the initial demand forecast is to be adapted to a second set of time slots in the forecast day, the second set of time slots including more or fewer time slots than the initial set of time slots;
generating a polynomial demand curve for the initial set of time slots of the initial demand forecast, including selecting a degree of a polynomial function to fit the initial set of values for the initial set of time slots of the initial demand forecast;
performing one or more curve shaping operations on the polynomial demand curve to fit a scaled version of the polynomial demand curve to the second set of time slots to obtain a scaled polynomial demand curve, the curve shaping operations including increasing scaling of a time value of the polynomial function when the second set of time slots includes more time slots than the initial set of time slots and decreasing scaling of the time value of the polynomial function when the second set of time slots includes fewer time slots than the initial set of time slots; and
computing the second demand forecast comprising the second set of values for the second set of time slots using values interpolated from the scaled polynomial demand curve,
wherein the second demand forecast adapts the initial demand forecast to the new or different time slots.

11. The system of claim 10 wherein the polynomial demand curve is fit to the initial set of values for the initial set of time slots associated with the initial demand forecast and then scaled to fit the second set time slots associated with the second demand forecast.

12. The system of claim 10 wherein the one or more curve shaping operations are performed on the polynomial demand curve to obtain the scaled polynomial demand curve in a manner that preserves one or more aspects of the initial demand forecast.

13. The system of claim 12 wherein aspects of the initial demand forecast that are preserved during the curve shaping operations includes one or more of (i) peak demand values of the initial demand forecast and (ii) timing information associated with the initial demand forecast.

14. The system of claim 10 further comprising performing peak detection to identify peaks in the initial set of values for the initial set of time slots of the initial demand forecast.

15. The system of claim 15 wherein the operation of performing peak detection comprises:
establishing a threshold to be applied to the initial set of values for the initial set of time slots;
identifying peak periods in the initial set of values that comprise three or more consecutive time slots having a value exceeding the threshold;
detecting a maximum value in each peak period; and
identifying the detected maximum in each peak period as a peak.

16. The system of claim 15 wherein the operations further comprise merging outliers including:
identifying non-peak periods in the initial set of values that comprise two or fewer consecutive time slots having a value exceeding the threshold; and
merging the initial set of time slots into the nearest peak or non-peak periods in the initial demand forecast.

17. The system of claim 14 wherein the operations further comprise:
segmenting the initial demand forecast into one or more segments in accordance with the detected peaks;
selecting each segment that includes more or fewer time slots than the corresponding initial set of time slots for the segment;
generating a polynomial demand curve for each selected segment while unselected segments remain unchanged to obtain a piecewise modified polynomial demand curve; and
computing the second demand forecast comprising the second set of values for the second set of time slots using values interpolated from the piecewise modified polynomial demand curve.

18. The system of claim 17 wherein generating a polynomial demand curve for each of the selected segments includes (i) selecting a degree of a polynomial function to fit the initial set of values for the initial set of time slots of the initial demand forecast and (ii) fitting the polynomial function of the selected degree to the second set of time slots in the segment.

19. A non-transitory computer readable storage medium adapted to store programmed computer code executable by a computer hardware server for implementing a machine learning system for forecasting demand on a forecast date, the machine learning system configured to perform operations to adapt demand forecasts to new or different time slots, the operations comprising:
computing an initial demand forecast comprising an initial set of values for an initial set of time slots in a forecast day based on processing demand data associated with the initial set of time slots;
receiving an indication that the initial demand forecast is to be adapted to a second set of time slots in the forecast day, the second set of time slots including more or fewer time slots than the initial set of time slots;
generating a polynomial demand curve for the initial set of time slots of the initial demand forecast, including selecting a degree of a polynomial function to fit the initial set of values for the initial set of time slots of the initial demand forecast;
performing one or more curve shaping operations on the polynomial demand curve to fit a scaled version of the polynomial demand curve to the second set of time slots to obtain a scaled polynomial demand curve, the curve shaping operations including increasing scaling of a time value of the polynomial function when the second set of time slots includes more time slots than the initial set of time slots and decreasing scaling of the time value of the polynomial function when the second set of time slots includes fewer time slots than the initial set of time slots; and
computing the second demand forecast comprising the second set of values for the second set of time slots using values interpolated from the scaled polynomial demand curve,
wherein the second demand forecast adapts the initial demand forecast to the new or different time slots.

20. The non-transitory computer readable storage medium of claim 19 wherein:
the polynomial demand curve is fit to the initial set of values for the initial set of time slots associated with the initial demand forecast and then scaled to fit the second set of time slots associated with the second demand forecast; and
the one or more curve shaping operations are performed on the polynomial demand curve to obtain the scaled polynomial demand curve in a manner that preserves one or more aspects of the initial demand forecast.
